(19) United States
(12) Patent Application Publication
(10) Pub. No.: US 2011/0143011 A1
(43) Pub. Date: Jun. 16, 2011

(54) GRANOLA CEREAL AND METHODS OF MAKING THE SAME

(76) Inventor: Mark Edward Meissner, San Luis Obispo, CA (US)

(21) Appl. No.: 13/022,807

(22) Filed: Feb. 8, 2011

Related U.S. Application Data
(63) Continuation of application No. 12/405,069, filed on Mar. 16, 2009.
(60) Provisional application No. 61/302,401, filed on Feb. 8, 2010.

(51) Int. Cl. A23L 1/10

(52) U.S. Cl. 426/618

(57) ABSTRACT

A method of making a cereal product in one embodiment includes mixing at least the following ingredients together to form a primarily granular mixture: between about 50% and about 90% oats, a non-sugar sweetener present in a volumetric ratio of from about 1:1000 to about 1:3000, between about 1% and about 10% ground flaxseed meal, between about 1% and about 7% olive oil, and between 0% and about 3% salt. The method further includes spreading the mixture on a cooking surface; baking the mixture on the cooking surface until the mixture is toasted; and disrupting the mixture at least once during the baking. Various embodiments of a baked cereal product are also disclosed.

### RELATED APPLICATIONS

This application claims priority to U.S. Provisional Patent Appl. No. 61/302,401, filed on Feb. 8, 2010, and which is herein incorporated by reference.

This application is related to U.S. patent application Ser. No. 12/405,069, filed Mar. 16, 2009, and which is herein incorporated by reference.

### FIELD OF THE INVENTION

The present invention relates to food products, and more specifically this invention relates to granola food products.

### BACKGROUND

Many different granola based food products exist in the marketplace today. However, to produce these food products, often times manufacturing to create pressed flakes from ground grains, nuts, and/or seeds is utilized. Also, in some cases, clusters are formed where processing takes place to form the clusters. Additionally, many of these granola based products may utilize cooking techniques such as frying, grilling, drying, etc. that may add additional, unwanted constituents to the food product.

Moreover, such products tend to have a high sugar content, increasing the calories per unit serving. Thus, such products may provide an illusion of being a “health food” when in fact, the high sugar levels may cause consumers to unknowingly exceed their daily recommended caloric intake.

Therefore, it would be beneficial to have a heretofore-unknown granola-type food product which could be made through more efficient manufacturing techniques.

### BRIEF DESCRIPTION OF THE DRAWINGS

FIG. 1 is a flow diagram of a method according to one embodiment.

For a fuller understanding of the nature and advantages of the present invention, as well as the preferred mode of use, reference should be made to the following detailed description read in conjunction with the accompanying drawings.

### DETAILED DESCRIPTION

The following paragraphs describe certain features and combinations of features that can be used in connection with the invention and each embodiment, as generally described below. Also, particular features described hereinafter can be used in combination with other described features in each of the various possible combinations and permutations. As such, the invention is not limited to the specifically described embodiments.

Unless otherwise specifically defined herein, all terms are to be given their broadest possible interpretation and scope including one or more meanings implied from the specification as well as one or more meanings understood by those skilled in the art and/or as defined in dictionaries, treatises, etc.

The following description is made for the purpose of illustrating the general principles of the present invention and is not meant to limit the inventive concepts claimed herein. Further, particular features described herein can be used in combination with other described features in each of the various possible combinations and permutations.

It must also be noted that, as used in the specification and the appended claims, the singular forms “a,” “an” and “the” include plural referents unless otherwise specified.

According to one general embodiment, a method of making a cereal product comprises mixing at least the following ingredients together to form a primarily granular mixture: between about 50% and about 85% oats, between about 5% and about 12% sweetener, between about 1% and about 7% ground flaxseed meal, between about 1% and about 5% olive oil, and between 0% and about 2% salt; spreading the mixture on a cooking surface; baking the mixture on the cooking surface until the mixture is toasted; and disrupting the mixture at least once during the baking.

In another general embodiment, a method of making a cereal product consists essentially of mixing the following ingredients together to form a primarily granular mixture: between about 50% and about 80% oats, between about 5% and about 10% sweetener, between about 1% and about 7% ground flaxseed meal, between about 1% and about 5% olive oil, between 0% and about 2% salt, and optionally, between about 2% and about 10% nuts; spreading the mixture on a cooking surface; baking the mixture on the cooking surface until the mixture is toasted; and disrupting the mixture at least once during the baking.

In another general embodiment, a baked cereal product comprises a primarily granular baked mixture of the following ingredients: between about 50% and about 85% oats, between about 5% and about 12% sweetener, between about 1% and about 7% ground flaxseed meal, between about 1% and about 5% olive oil, and between 0% and about 2% salt.

In yet another general embodiment, a baked cereal product consists essentially of a primarily granular baked mixture of the following ingredients: between about 50% and about 85% oats, between about 5% and about 12% sweetener, between about 1% and about 7% ground flaxseed meal, between about 1% and about 5% olive oil, between 0% and about 2% salt, optionally, between about 2% and about 10% nuts, and optionally, between about 2% and about 10% fruit.

In another general embodiment, a method of making a cereal product includes mixing at least the following ingredients together to form a primarily granular mixture: between about 50% and about 90% oats, a non-sugar sweetener present in a volumetric ratio of from about 1:1000 (vol. sweetener in powdered form or its equivalent to vol. of the entire mixture before baking and/or forming) to about 1:3000, between about 1% and about 10% ground flaxseed meal, between about 1% and about 7% olive oil, and between 0% and about 3% salt; spreading the mixture on a cooking surface; baking the mixture on the cooking surface until the mixture is toasted; and disrupting the mixture at least once during the baking.

In a further general embodiment, a cereal product includes between about 50% and about 90% oats, a non-sugar sweetener present in a volumetric ratio of from about 1:1000 (vol. sweetener in powdered form or its equivalent to vol. of the entire mixture before baking and/or forming) to about 1:3000, between about 1% and about 10% ground flaxseed meal, between about 1% and about 7% olive oil, and between 0% and about 3% salt.

Note that all percentages (%) used herein are volumetric relative to the total volume of the mixture. Moreover, the term “about” may mean the number plus or minus 10% of the number. Thus, for example, “about 5%” may mean 5±0.5%, though numbers outside these bounds are contemplated.

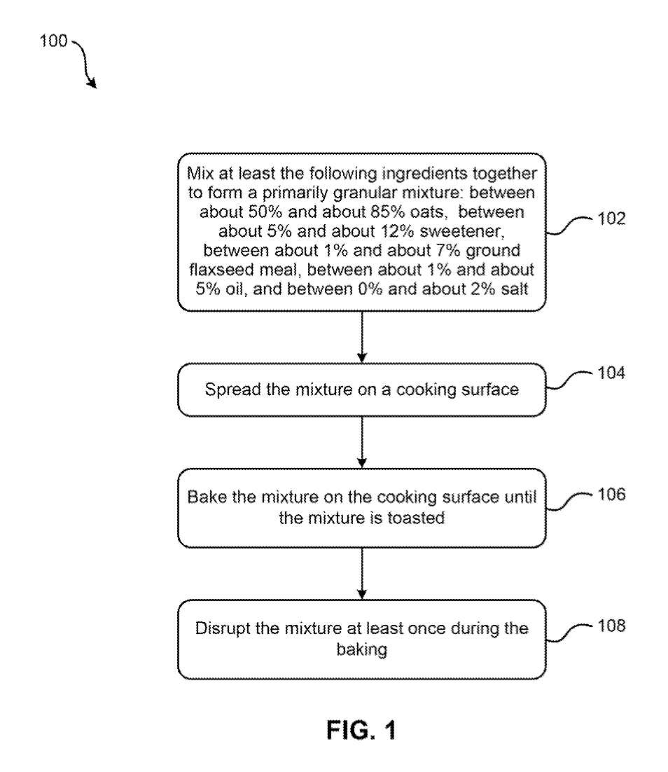

Now referring to FIG. 1, a method 100 of making a cereal product is described according to one embodiment. The method 100 may be carried out in any environment, and may include additional steps not specifically described herein. The method 100 may be performed in a batch, in a steady state process, or in a combination thereof.

In operation 102, at least the following ingredients are mixed together to form a primarily granular mixture. Between about 50% and about 85% oats are included, preferably between about 65% and about 75%, alternatively between about 50% and 75%, alternatively between about 60% and 80%, alternatively between about 70% and 85%, etc. Also, between about 5% and about 12% sweetener is included, preferably between about 6% and about 10%, alternatively between about 5% and about 8%, alternatively between about 7% and about 12%, etc. Additionally, between about 1% and about 7% ground flaxseed meal is included, preferably between about 1% and about 5%, alternatively between about 2% and about 6%, etc. Also, between about 1% and about 5% olive oil is included, preferably between about 2% and about 4%. In addition, between 0% and about 2% salt is included. Any type of sweetener may be used alone or in combination, such as brown sugar, molasses, honey, sugar, aspartame, sucralose, saccharine, acesulfame potassium, acesulfame-K, fructose, sucrose, glucose, xylitol, malitol, etc. Also, the type of oil to be used is olive oil.

Of course, other ingredients may be included in the mixture also, such as preservatives, coloring agents, texture enhancing additives, etc.

In operation 104, the mixture is spread on a cooking surface (e.g., a pan, a dish, a conveyor belt, a cooking stone, etc.). The mixture may be spread mechanically and/or manually by hand, with a spoon, by distributing about evenly across the cooking surface, etc.

In operation 106, the mixture is baked on the cooking surface until the mixture is toasted. Toasting can be evidenced by a darkened color on portions of the mixture, a generally golden color, a toasted smell of the mixture, etc. One of skill in the art would be able to determine when the mixture has been toasted, without allowing the mixture to burn or char.

In operation 108, the mixture is disrupted at least once during the baking (e.g., by stirring, by agitating, by lifting, by shaking, by dropping, etc.). Of course, in some embodiments, the mixture may be continuously disrupted, periodically disrupted, etc. Also, the disruption may be automatically and/or manually caused. For example, the cooking surface may be automatically shaken every two minutes during the baking. In another example, an operator may stir the mixture halfway through the baking.

In some embodiments, the method 100 may further comprise removing substantially all lumps from the mixture prior to the baking. The removal of lumps can generally be effected by any suitable mechanism, including agitation, physical dismantling, etc. The term “substantially all lumps” may include, for instance, removing greater than about 50%, greater than about 75%, greater than about 90% of conglomerations of 5 or more granules of oats. In another approach, the term “substantially all lumps” may include removing greater than about 50%, greater than about 75%, greater than about 90% of conglomerations having a dimension greater than about ¼ inch, ⅜ inch, ½ inch, etc.

In some preferred embodiments, the mixture may include no flakes, such as oat flakes, corn flakes, bran flakes, wheat flakes, etc.

In some more embodiments, the mixture after the baking may be primarily granular. Also, the primarily granular baked mixture may be placed in packaging. In some further embodiments, the packaging may act to preserve the mixture, to advertise the mixture, to provide a surface to display information about the mixture, such as name, date packaged, nutritional information, etc.

In some approaches, between about 2% and about 10% nuts may be added to the mixture prior to the baking. In more approaches, between about 6% and about 10% may be included, alternatively between about 2% and about 8% may be included, etc. Any type of nuts may be added, such as peanuts, almonds, cashews, walnuts, pine nuts, etc. In addition, seeds may be added to the mixture, such as sunflower seeds, flaxseeds, etc. Also, the nuts and/or seeds may be chopped, crushed, sliced, etc., prior to being added to the mixture. The nuts and/or seeds may also be treated prior to adding to the mixture, such as by applying a coating, removing a skin and/or shell, etc.

In more approaches, between about 2% and about 10% fruit may be added to the mixture after the baking. In more approaches, between about 6% and about 10% may be included, alternatively between about 2% and about 8% may be included, etc. Any type of fruit may be added, such as bananas, dates, cranberries, oranges, strawberries, etc. In addition, the fruit may be dried and/or treated prior to being added to the mixture, such as by adding a preservative, flavor enhancer, etc.

According to one embodiment, a baked cereal product comprises a primarily granular baked mixture of the following ingredients. Between about 50% and about 85% oats are included, preferably between about 65% and about 75%, alternatively between about 50% and 75%, alternatively between about 60% and 80%, alternatively between about 70% and 85%, etc. Also, between about 5% and about 12% sweetener is included, preferably between about 6% and about 10%, alternatively between about 5% and about 8%, alternatively between about 7% and about 12%, etc. Additionally, between about 1% and about 7% ground flaxseed meal is included, preferably between about 1% and about 5%, alternatively between about 2% and about 6%, etc. Also, between about 1% and about 5% olive oil is included, preferably between about 2% and about 4%. In addition, between 0% and about 2% salt is included. Any type of sweetener may be used alone or in combination, such as brown sugar, molasses, honey, sugar, aspartame, sucralose, fructose, sucrose, etc. Also, the type of oil to be used is olive oil.

According to some embodiments, there may be no flakes in the mixture, such as bran flakes, corn flakes, wheat flakes, etc.

In more embodiments, the primarily granular baked mixture is in a package. The package may include a box with graphics, writing, information, etc. on the exterior and/or interior. There may also be additional packaging, such as a sealed and/or re-sealable plastic bag inside of the other packaging.

In additional embodiments, the cereal product may include between about 2% and about 10% nuts, alternatively between about 5% and about 8%, alternatively between about 4% and about 6%, etc. Any type of nuts may be added, such as peanuts, almonds, cashews, walnuts, pine nuts, etc. In addition, seeds may be added to the mixture, such as sunflower seeds, flaxseeds, etc. Also, the nuts and/or seeds may be chopped, crushed, sliced, etc., prior to being added to the mixture. The nuts and/or seeds may also be treated prior to adding to the mixture, such as by applying a coating, removing a skin and/or shell, etc.

In more approaches, between about 2% and about 10% fruit may be added to the mixture after the baking. In more approaches, between about 6% and about 10% may be included, alternatively between about 2% and about 8% may be included, etc. Any type of fruit may be added, such as bananas, dates, cranberries, raisins, oranges, strawberries, etc. In addition, the fruit may be dried and/or treated prior to being added to the mixture, such as by adding a preservative, flavor enhancer, etc.

In another embodiment, the cereal product may comprise about 70% oats, about 8% sweetener, about 3% ground flaxseed meal, about 3% oil, less than about 1% salt, about 8% nuts, and about 8% dried fruit. Of course, these percentages may be increased or decreased, possibly by about 3% to about 5%, or even sometimes by about 10%. Also, the fruits and/or nuts may be treated prior to being added to the mixture, such as by adding a preservative, flavor enhancer, etc.

In yet another embodiment, a baked cereal product consists essentially of a primarily granular baked mixture of the following ingredients. Between about 50% and about 85% oats are included, preferably between about 65% and about 75%, alternatively between about 50% and 75%, alternatively between about 60% and 80%, alternatively between about 70% and 85%, etc. Also, between about 5% and about 12% sweetener is included, preferably between about 6% and about 10%, alternatively between about 5% and about 8%, alternatively between about 7% and about 12%, etc. Additionally, between about 1% and about 7% ground flaxseed meal is included, preferably between about 1% and about 5%, alternatively between about 2% and about 6%, etc. Also, between about 1% and about 5% olive oil is included, preferably between about 2% and about 4%. In addition, between 0% and about 2% salt is included. In addition, between about 2% and about 10% nuts may optionally be included, and between about 2% and about 10% fruit may optionally be included. Any type of sweetener may be used alone or in combination, such as brown sugar, molasses, honey, sugar, aspartame, sucralose, fructose, sucrose, etc. Also, in variations on the embodiments disclosed herein, any type of oil may be used alone or in combination, such as flaxseed oil, vegetable oil, sesame seed oil, canola oil, palm oil, linseed oil, etc.

In particularly preferred embodiments, only olive oil is used as the oil. This olive oil is superior in health benefits versus using the types of cooking oils noted in the variations noted in the preceding paragraph. The benefits of using olive oil in the process of making a cereal according to various embodiments include the fact that it results in a healthier product. Olive oil provides the product with healthier polyunsaturated and monounsaturated fats and also contains high levels of omega-3 and omega-6 fatty acids. In one illustrative embodiment, a two-ounce serving of the granola includes 640 mg of omega-3 and 1070 mg of omega-6 fatty acids.

According to some embodiments, any type of fruit may be added, such as bananas, dates, cranberries, raisins, oranges, strawberries, goji berries, apples, etc. In addition, the fruit may be dried and/or treated prior to being added to the mixture, such as by adding a preservative, flavor enhancer, etc.

In some more embodiments, any type of nuts may be added, such as peanuts, almonds, cashews, walnuts, pine nuts, etc. In addition, seeds may be added to the mixture, such as sunflower seeds, flaxseeds, etc. Also, the nuts and/or seeds may be chopped, crushed, sliced, etc., prior to being added to the mixture. The nuts and/or seeds may also be treated prior to adding to the mixture, such as by applying a coating, removing a skin and/or shell, etc.

In alternate embodiments, which beneficially have a significantly lower amount of calories per unit product, a nonsugar sweetener (including sweeteners having lower caloric value than sugar) may be used at lower concentrations than the ranges presented above. Several illustrative nonsugar sweeteners are presented above, and can be used. Preferably, such sweetener is a natural sweetener, e.g., derived from natural sources, such as sucralose, stevia, etc.

In particularly preferred, lower calorie, embodiments, powdered or granulated stevia is used as the sole sweetener or in combination with one or more other sweeteners. The stevia may be present in a volumetric ratio of from about 1:1000 (vol. stevia in powdered form or its equivalent to vol. entire mixture before baking and/or forming) to about 1:3000. A particularly preferred ratio for the particular recipes presented herein is between about 1:1200 and about 1:2000.

In stevia-containing embodiments, as well as other embodiments using a non-sugar sweetener, a spice is preferably added to mask the aftertaste of the stevia. Preferred spices include cinnamon, nutmeg, allspice, pumpkin allspice, ginger, cardomin and cloves. The spices are preferably present in the product in a volumetric ratio of from about 1:1000 (vol. spices in powdered form or its equivalent to vol. entire mixture before baking and/or forming) to about 1:3000. A particularly preferred ratio for the particular recipes presented herein is between about 1:1200 and about 1:2000. In some approaches, the amount of spices added may be approximately the same as the amount of stevia added.

While various embodiments have been described above, it should be understood that they have been presented by way of example only, and not limitation. Thus, the breadth and scope of an embodiment should not be limited by any of the above-described exemplary embodiments, but should be defined only in accordance with the following claims and their equivalents.

What is claimed is:

1. A method of making a cereal product, the method comprising:
mixing at least the following ingredients together to form a primarily granular mixture:
between about 50% and about 90% oats,
a non-sugar sweetener present in a volumetric ratio of from about 1:1000 to about 1:3000,
between about 1% and about 10% ground flaxseed meal,
between about 1% and about 7% olive oil, and
between 0% and about 3% salt;
spreading the mixture on a cooking surface;
baking the mixture on the cooking surface until the mixture is toasted; and
disrupting the mixture at least once during the baking.

2. The method of claim 1, further comprising adding at least one spice in a volumetric ratio of from about 1:1000 (vol. spices in powdered form or its equivalent to vol. of the entire mixture before baking and/or forming) to about 1:3000

3. The method of claim 1, further comprising removing substantially all lumps from the mixture prior to the baking.

4. The method of claim 1, with the proviso that none of the ingredients are flakes.

5. The method of claim 1, wherein the mixture after the baking is primarily granular, and further comprising packaging the primarily granular baked mixture.

6. The method of claim 1, further comprising adding between about 2% and about 10% nuts to the mixture prior to the baking.

7. The method of claim 1, further comprising adding between about 2% and about 10% fruit to the mixture after the baking.

8. A baked cereal product, comprising:
a primarily granular baked mixture of the following ingredients:
between about 50% and about 90% oats,
a non-sugar sweetener present in a volumetric ratio of from about 1:1000 (vol. sweetener in powdered form or its equivalent to vol. of the entire mixture before baking and/or forming) to about 1:3000,
between about 1% and about 10% ground flaxseed meal,
between about 1% and about 7% olive oil, and
between 0% and about 3% salt.

9. The cereal product of claim 8, with the proviso that flakes are not present in the mixture.

10. The cereal product of claim 8, wherein the primarily granular baked mixture is in a package.

11. The cereal product of claim 8, further comprising between about 2% and about 10% nuts.

12. The cereal product of claim 8, further comprising between about 2% and about 10% fruit.

13. The cereal product of claim 8, comprising:
about 70% oats,
about 8% sweetener,
about 3% ground flaxseed meal,
about 3% olive oil,
less than about 1% salt,
about 8% nuts, and
about 8% dried fruit.
optionally, between about 2% and about 10% fruit.
